(19) United States
(12) Patent Application Publication
(10) Pub. No.: US 2021/0226200 A1
(43) Pub. Date: Jul. 22, 2021

(54) SOLID-STATE BATTERY

(71) Applicant: HONDA MOTOR CO., LTD., Tokyo (JP)

(72) Inventors: Noriaki KAMAYA, Saitama (JP); Hiroto MAEYAMA, Saitama (JP); Wataru SHIMIZU, Saitama (JP)

(21) Appl. No.: 17/131,786

(22) Filed: Dec. 23, 2020

(30) Foreign Application Priority Data
Jan. 21, 2020 (JP) 2020-007394

(51) Int. Cl. H01M 4/36; H01M 10/0562; H01M 4/46; H01M 10/052; H01M 10/0585

(52) U.S. Cl. CPC H01M 4/366; H01M 10/0562; H01M 4/463; H01M 2004/027; H01M 10/0585; H01M 2300/0068; H01M 10/052

(57) ABSTRACT

The present invention decreases internal resistance in a solid-state battery having a LiAl system negative electrode mixture.

A solid-state battery (1) includes: a positive electrode layer (20), a negative electrode layer (30), and a solid electrolyte layer (40) disposed between the positive electrode layer (20) and negative electrode layer (30), in which the negative electrode layer (30) includes an aluminum layer (31) contacting the solid electrolyte layer (40), and an aluminum-lithium alloy layer (33).

This application is based on and claims the benefit of priority from Japanese Patent Application No. 2020-007394, filed on 21 Jan. 2020, the content of which is incorporated herein by reference.

### BACKGROUND OF THE INVENTION

### Field of the Invention

The present invention relates to a solid-state battery equipped with a positive electrode layer, a negative electrode layer, and a solid electrolyte layer.

### Related Art

Conventionally, a negative electrode containing an aluminum-lithium alloy is considered to be high capacity; however, in the case of using in a lithium-ion battery made using a common organic solvent, since the LiAl ionizes and elutes in the solvent, or atomizes, by repeated charging/discharging, it has been considered that the durability of lithium-ion batteries have become low (for example, refer to Non-patent Document 1).

For this reason, it has been difficult to make the most of the original characteristics of aluminum-lithium alloy, even when using aluminum-lithium alloy as the negative electrode of a lithium-ion battery.

On the other hand, aluminum-lithium alloys have been expected as the materials of the negative electrode of solid-state batteries, which do not use organic solvents, etc.

For example, technology for forming the negative electrode layer of a solid-state battery by press molding a sulfide-based solid electrolyte material and powder aluminum-lithium alloy has been proposed (for example, refer to Patent Document 1).
Patent Document 1: Japanese Unexamined Patent Application, Publication No. 2014-154267
Non-Patent Document 1: L. Y. Beaulieu et al., “Colossal Reversible Volume Changes in Lithium Alloys”, Electrochemical and Solid-State Letters, 4(9), A137-A140 (2001)

### SUMMARY OF THE INVENTION

However, in the case of using a powder aluminum-lithium alloy, there is a tendency for the discharge capacity to decline when repeating charge/discharge.

The present invention has an object of providing a solid-state battery for which the discharge capacity hardly declines even when repeating charge/discharge.

A first aspect of the present invention relates to a solid-state battery including: a positive electrolyte layer; a negative electrode layer; and a solid electrolyte layer disposed between the positive electrode layer and the negative electrode layer, in which the negative electrode layer contains a first aluminum layer contacting the solid-electrolyte layer, and an aluminum-lithium alloy layer.

According to the first aspect of the present invention, the first aluminum layer 31 contacts with the solid electrolyte layer 40; therefore, in the case of discharging the solid-state battery 1, even if the lithium in the aluminum-lithium alloy layer 33 migrating to a side of the solid electrolyte layer 40, will alloy with the aluminum in the aluminum layer 31 prior to reaching the solid electrolyte layer 40.

For this reason, the lithium hardly effuses from the side of the solid electrolyte layer 40 by discharging, and the discharge capacity of the solid-state battery 1 hardly declines even when repeating charge/discharge.

According to a second aspect of the present invention, in the solid-state battery as described in the first aspect, X in a compositional ratio LiₓAl₁₋ₓ of lithium and aluminum in the negative electrode layer is in the range of 0.1 to 0.5.

According to the second aspect of the present invention, the internal resistance of the solid-state battery is decreased, while securing the total amount of aluminum and increasing the energy density.

According to a third aspect of the present invention, in the solid-state battery as described in the first or second aspect, the negative electrode layer has a ratio I₂₂₀/I₁₁₀ of reflection intensity I₂₂₀ of LiAl relative to reflection intensity I₁₁₀ of Al in X-ray diffraction measurement using CuKα radiation in a surface on a side of the solid electrolyte layer in the range of 0.1 to 10.

According to the third aspect of the present invention, the aluminum layer is sufficiently alloyed on the solid electrolyte layer side of the negative electrode layer, and the negative electrode lithium tends to be released to the positive electrode side without being absorbed to aluminum during discharge; therefore, the internal resistance of the solid-state battery is decreased.

According to a fourth aspect of the present invention, in the solid-state battery as described in any one of the first to third aspects, a film thickness of the negative electrode layer is in the range of 10 to 400 μm.

According to the fourth aspect of the present invention, by the film thickness of the negative electrode layer 30 being the appropriate range, the aluminum and lithium is suppressed from decreasing from the negative electrode layer 30 by charging/discharging.

It is thereby possible to provide a solid-state battery 1 for which the discharge capacity more hardly declines even when repeating charge/discharge.

According to a fifth aspect of the present invention, in the solid-state battery as described in any one of the first to fourth aspects, the negative electrolyte layer further contains a second aluminum layer, wherein the aluminum-lithium alloy layer is disposed to be interposed between the first aluminum layer and the second aluminum layer.

According to the fifth aspect of the present invention, by arranging the aluminum layers to be divided into two layers, the internal resistance of the solid-state battery is decreased while maintaining the total amount of aluminum occupying the overall negative electrode layer.

This is because it is possible to thinly form the first aluminum layer on the side of the solid electrode layer, and the negative electrode lithium will tend to be released during discharge.

According to a sixth aspect of the present invention, in the solid-state battery as described in any one of the first to fifth aspects, the solid electrolyte layer consists of a sulfide-based solid electrolyte material.

According to the sixth aspect of the present invention, differing from the case of using aluminum-lithium alloy as the negative electrode of a lithium-ion battery made using organic solvent, with the sulfide-based solid-state battery, it is possible to maintain high reliability without the aluminum-lithium alloy ionizing and eluting to the solid electrolyte.

It is thereby possible to provide a sulfide-based solid-state battery for which discharge capacity hardly declines even when repeating charging/discharging.

### BRIEF DESCRIPTION OF THE DRAWINGS

FIG. 1 is a view schematically representing a cross section of a solid-state battery according to a first embodiment of the present invention;

FIG. 2 is a graph showing an X-ray diffraction spectrum of Comparative Example 1 immediately after charge/discharge;

FIG. 3 is a graph showing the X-ray diffraction spectrum of Example 1 immediately after charge/discharge;

FIG. 4 is a graph showing the X-ray diffraction spectrum of Example 2 immediately after charge/discharge;

FIG. 5 is a graph showing the change for every composition ratio in the DCR resistance of Examples 1 and 2, and Comparative Example 1;

FIG. 6 is a graph showing the change for every composition ratio in the charge/discharge efficiency of Examples 1 and 2, and Comparative Example 1;

FIG. 7 is a graph showing the change for every composition ratio in the discharge capacity of Examples 1 and 2, and Comparative Example 1; and

FIG. 8 is a view schematically representing the cross section of a solid-state battery according to a second embodiment of the present invention.

### DETAILED DESCRIPTION OF THE INVENTION

Hereinafter, a first embodiment of the present invention will be explained in detail while referencing the drawings.

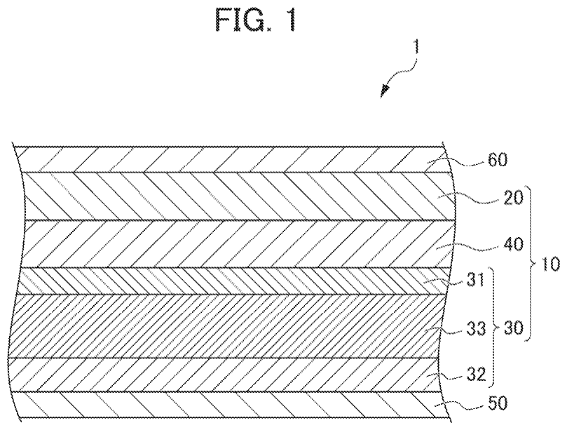

FIG. 1 is an explanatory drawing showing a cross section of a solid-state battery according to the first embodiment of the present invention.

As shown in FIG. 1, the solid-state battery 1 includes a battery main body 10, a negative electrode collector 50, and a positive electrode collector 60.

It should be noted that, in the embodiments, solid-state battery is a battery made by taking a battery and making it entirely solid state.

The negative electrode collector 50 and positive electrode collector 60 are plate members having conductivity that sandwich the battery main body 10 from both sides.

The negative electrode collector 50 has a function of performing current collection of the negative electrode layer 30, and the positive electrode collector 60 has a function of performing current collection of the positive electrode layer 20.

The electrode collector material used in the negative electrode collector 50 is not particularly limited so long as being a material having conductivity, and copper, nickel, stainless steel, vanadium, magnesium, iron, titanium, cobalt, zinc, etc. can be exemplified. Thereamong, copper and nickel are preferable due to being superior in conductivity and superior in current collection.

As the shape and thickness of the negative electrode collector 50, they are not particularly limited so long as being extents for which it is possible to perform current collection of the negative electrode layer 30.

As the positive electrode collector material used in the positive electrode collector 60, it is possible to exemplify vanadium, aluminum, stainless steel, gold, platinum, manganese, iron, titanium, etc., and thereamong, it is preferably aluminum.

As the shape and thickness of the positive electrode collector 60, they are not particularly limited so long as being extents for which it is possible to perform current collection of the positive electrode layer 20.

The battery rain body 10 includes the positive electrode layer 20 functioning as the positive electrode; the negative electrode layer 30 functioning as the negative electrode; and the conductive solid electrolyte layer 40 positioned between the positive electrode layer 20 and negative electrode layer 30.

The positive electrode layer 20 is formed by press molding a material containing positive electrode active material, and a sulfide-based solid electrolyte.

As the positive electrode active material, for example, a layered positive electrode active material such as LiCo₂, LiNiO₂, LiCo_{1/3}Ni_{1/3}Mn_{1/3}O₂, LiVO₂, and LiCrO₂; spinel-type positive electrode active material such as LiMnO₄, Li(Ni_{0.25}Mn_{0.75})₂O₄, LiCoMnO₄, and Li₂NiMn₃O₈; and olivine-type positive electrode active material such as LiCoPO₄, LiMnPO₄, and LiFePO₄ Can be exemplified.

The sulfide-based solid electrolyte material used in the positive electrode layer 20 normally contains a metal element (M) which becomes a conducting ion, and sulfur (S).

As the above M, for example, it is possible to exemplify Li, Na, K, Mg, Ca, etc., and thereamong, Li is preferable.

In particular, the sulfide-based solid electrolyte material preferably contains Li, A (A is at least one type selected from the group consisting of P, Si, Ge, Al and B), and S.

Furthermore, the above A is preferably P (phosphorus).

Furthermore, the sulfide-based solid electrolyte material may contain a halogen such as Cl, Br and I.

This is because ion conductivity improves by containing a halogen.

In addition, the sulfide-based solid electrolyte material may contain oxygen (O).

As the sulfide-based solid electrolyte material having Li ion conductivity, for example, it is possible to exemplify Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n are positive numbers; Z is any of Ge, Zn, Ga), Li₂S—GeS₂, Li₂S—SiS₂—Li₃PO₄, and Li₂S—SiS₂-LiₓMO_{y} (provided that x and y are positive numbers; M is any of P, Si, Ge, B, Al, Ga, In).

It should be noted that the description of the above “Li₂S—P₁S₅” indicates the sulfide-based solid electrolyte material made using a source composition containing Li₂S and P₂S₅, and is the same for other descriptions.

In addition, in a case of the sulfide-based solid electrolyte material being made using a raw material composition containing Li₂S and P₂S₅, the proportion of Li₂S relative to the total of Li₂S and P₂S₅ is preferably in the range of 70 mol % to 80 mol %, for example, more preferably within the range of 72 mol % to 78 mol %, and even more preferably within the range of 74 mol % to 76 mol %.

This is because it is possible to establish as a sulfide-based solid electrolyte material having an ortho composition or composition close thereto, and possible to establish as a sulfide-based solid electrolyte material having high chemical stability.

Herein, ortho generally refers to having the highest degree of hydration among oxo acids obtained by hydrating the same oxides.

In this form, a crystal composition to which the most Li₂S is added by sulfide is referred to as ortho composition.

In the Li₂S—P₂S₅ system, Li₃PS₄ corresponds to the ortho composition.

In the case of the sulfide-based solid electrolyte material of the Li₂S—P₂S₅ system, the proportions of Li₂S—P₂S₅ obtaining the ortho composition are Li₂S:P₂S₅=75:25 by mole basis.

It should be noted that, in the case of using Al₂S₃ or B₂S₃ in place of P₂S₅ in the above-mentioned raw material composition, the preferred ranges are the same.

In the Li₂S—Al₂S₃ system, Li₃AlS₃ corresponds to the ortho composition, and in the Li₂S—B₂S₃ system, Li₃BS₃ corresponds to the ortho composition.

In addition, in the case of the sulfide-based solid electrolyte material being made using a raw material composition containing Li₂S and SiS₂, the proportion of Li₂S relative to the total of Li₂S and SiS₂ is preferably in the range of 60 mol % to 72 mol %, for example, is more preferably within the range of 62 mol % to 70 mol %, and even more preferably within the range of 64 mol % to 68 mol %.

This is because it is possible to establish as a sulfide-based solid electrolyte material having the ortho composition or composition close thereto, and it is possible to establish as a sulfide-based solid electrolyte material having high chemical stability.

In the Li₂S—SiS₂ system, Li₄SiS₄ corresponds to the ortho composition.

In the case of the sulfide-based solid electrolyte material of the Li₂S—SiS₂ system, the proportions of LAS and SiS₂ obtaining the ortho composition are Li₂S:SiS₂=66.6:33.3 by mole basis.

It should be noted that, also for the case of using GeS₂ in place of SiS₂ in the above-mentioned raw material composition, the preferred ranges are the same.

In the Li₂S—GeS₂ system, Li₄GeS₄ corresponds to the ortho composition.

In addition, in the case of the sulfide-based solid electrolyte material being made using a raw material composition containing LiX (X=Cl, Br, I), the proportion of LiX is preferably within the range of 1 mol % to 60 mol %, for example, is more preferably within the range of 5 mol % to 50 mol %, and even more preferably within the range of 10 mol % to 40 mol %.

In addition, the sulfide-based solid electrolyte material may be sulfide glass, may be crystalline sulfide glass, and may be a crystalline material obtained by a solid phase method.

It should be noted that the sulfide glass can be obtained by performing mechanical milling (ball mill, etc.) on the raw material composition, for example.

In addition, the crystalline sulfide glass can be obtained by performing heat treatment at a temperature of at least the crystallization temperature on the sulfide glass, for example.

In addition, in the case of the sulfide-based solid electrolyte material being a Li-ion conductor, the Li-ion conductivity at room temperature is preferably at least 1×10⁻⁵ S/cm, for example, and more preferably at least 1×10⁻⁴S/cm.

In addition, the positive electrode layer 20 may contain, in addition to the aforementioned sulfide-based solid electrolyte and positive electrode active material, a conductive material, binder and solid electrolyte.

The negative electrode layer 30 is a member including a first aluminum layer 31 contacting the solid electrolyte layer 40, a second aluminum layer 32 contacting the negative electrode collector 50, and an aluminum-lithium alloy layer 33 arranged between the first aluminum layer 31 and second aluminum layer 32.

In the aluminum-lithium alloy layer 33, a lithium layer which is not alloyed may be included.

The first aluminum layer 31 and second aluminum layer 32 are layers with aluminum as the main component.

The aluminum-lithium alloy layer 33 is a plate, foil or film layer formed in the case of charging the solid-state battery 1, case of discharging the solid-stage battery 1, case of press molding aluminum and lithium, and case of producing the solid-state battery 1 by a bonding process described later.

It should be noted that, in the present disclosure, the aluminum-lithium alloy layer 33 is not limited to a layer with the aluminum-lithium alloy as the main component, and also contains a portion serving as the starting point for forming aluminum-lithium alloy.

In the present embodiment, the negative electrode layer 30 consists of only the first aluminum layer 31, second aluminum layer 32 and aluminum-lithium alloy layer 33.

The negative electrode layer 30 is formed by press molding plate-like (foil, thin film) aluminum and lithium, for example.

The negative electrode layer 30 containing the first aluminum layer 31, second aluminum layer 32 and aluminum-lithium alloy layer 33 is thereby formed.

It should be noted that the negative electrode layer 30 may be formed by depositing lithium on the plate-like (foil, thin film) aluminum by a sputtering method or the like.

The first aluminum layer 31 is arranged to contact with the solid electrolyte layer 40.

Herein, in the case of discharging the solid-state battery 1, although the lithium in the aluminum-lithium alloy layer 33 migrates to the side of the solid electrolyte layer 40, a part of the lithium stays inside the negative electrode layer 30 by alloying with the aluminum in the first aluminum layer 31 prior to reaching the solid electrolyte layer 40.

For this reason, so long as the film thickness of the first aluminum layer 31 is thick, lithium will hardly be released from the side of the solid electrolyte layer 40 of the first aluminum layer 31 during discharging.

The second aluminum layer 32 is arranged to contact with the negative electrode collector 50.

By arranging the aluminum layers to be divided into two layers, the internal resistance of the solid-state battery 1 is decreased while maintaining the total amount of aluminum occupying the overall negative electrode layer.

This is because it is possible to thinly form the first aluminum layer 31 on the side of the solid electrode layer 40, and the negative electrode lithium will tend to be released during discharge.

The molar ratio and mass ratio of lithium and aluminum in the negative electrode layer 30 are not particularly limited; however, in the present embodiment, the composition ratio Li_{X}Al_{1-X} (0≤X≤1) of lithium and aluminum in the negative electrode layer 30 is in the range of X=0.1 to 0.5.

The internal resistance of the solid-state battery is thereby decreased, while securing the total amount of aluminum and increasing the energy density.

The film thickness of the negative electrode layer 30 is not particularly limited; however, it is preferably 10 to 400 μm, and more preferably 20 to 200 μm.

In addition, at a stage prior to charging/discharging, the total of the film thickness of the first aluminum layer 31 and second aluminum layer 32 is 5 to 200 μm, for example, and is preferably 10 to 100 μm.

In addition, at a stage prior to charging/discharging, the film thickness of the first aluminum layer 31 is 5 to 100 μm, for example, and is preferably 25 to 50 μm.

In addition, at a stage prior to charging/discharging, the film thickness of the aluminum-lithium alloy layer 33 is 5 to 200 μm, for example, and is preferably 10 to 100 μm.

By the film thickness of the negative electrode layer 30 being the appropriate range, the aluminum and lithium is suppressed from decreasing from the negative electrode layer 30 by charging/discharging.

In addition, by setting the film thickness of the first aluminum layer 31 to the appropriate range, lithium is suppressed from decreasing from the negative electrode layer 30 during discharge.

The solid electrolyte layer 40 is a plate-like member formed from sulfide-based solid electrolyte material.

The sulfide-based solid electrolyte material is not particularly limited; however, it is possible to use the same material as the sulfide-based solid electrolyte material used in the positive electrode layer 20.

In addition, the production method of the solid-state battery 1 of the present embodiment includes a bonding step for obtaining the solid-state battery 1 by laminating a lithium layer above the second aluminum layer 32, laminating the first aluminum layer 31 above the lithium layer, laminating the solid electrolyte layer 40 above the first aluminum layer 31, and laminating the positive electrode layer 20 above the solid electrolyte layer 40, with the vertical direction as the lamination direction, for example.

As such a bonding step, overlapping in this order the negative electrode collector 50, second aluminum layer 32, lithium layer, aluminum layer 31 (negative electrode layer 30), solid electrolyte layer 40, positive electrode layer 20, and positive electrode collector 60, and then press molding can be exemplified.

By pressing the laminate body in a state arranging the first aluminum layer 31 and second aluminum layer 32 from above and below the lithium layer, the first aluminum layer 31 and second aluminum layer 32 react with the lithium layer, and the aluminum-lithium alloy layer 33 is formed.

By the lithium layer being pressed in a state sandwiched by the two aluminum layers, aluminum-lithium alloying progresses favorably.

The solid-state battery 1 including the positive electrode layer 20, negative electrode layer including the first aluminum layer 31, aluminum-lithium alloy layer 33 and second aluminum layer 32, and the solid electrolyte layer 40 is thereby produced.

It should be noted that a lithium layer may remain in the aluminum-lithium alloy layer 33, without the lithium layer being completely alloyed.

### EXAMPLES

Next, the present invention will be explained in further detail based on the Examples and Comparative Examples; however, the present invention is not to be limited thereto.

A ternary compound system positive electrode active material (LiCo_{1/3}Ni_{1/3}Mn_{1/3}O₂) on which surface coating by LiNbO₃ was conducted, a solid electrolyte, and conduction assistant were mixed by ball mill in the mass ratios of 75, 22, 3 wt %, respectively to prepare a positive electrode mixture.

A laminate body of the positive electrode layer 20 and solid electrolyte layer 40 was obtained by weighing 15 mg of this positive electrode mixture and 100 mg of the solid electrolyte, and press molding these with a molding pressure of 10 ton/cm² in a single axis press machine.

The negative electrode layers according to Comparative Example 1 and Examples 1 and 2 shown below were arranged on the opposite side to the positive electrode layer 20 of the solid electrolyte 40 to prepare a solid-state battery.

After the initial charge/discharge test and DCR resistance test, the solid electrolyte layer 40 and negative electrode layer were peeled off, and X-ray diffraction measurement was performed from a side of the solid electrolyte layer 40.

### Comparative Example 1

The negative electrode layer of Comparative Example 1 was made by overlapping aluminum foil with 100 μm thickness and lithium foil, and press molding at 0.5 ton/cm².

The negative electrode layer of Comparative Example 1, from a side of the solid electrolyte layer, is an aluminum layer, aluminum-lithium alloy layer and lithium layer.

### Example 1

The negative electrode layer of Example 1 was made by overlapping in this order a first aluminum foil with 50 μm thickness, lithium foil, and a second aluminum foil with 50 μm, and press molding at 0.5 ton/cm.

The negative electrode layer of Example 1, from a side of the solid electrolyte layer, is an aluminum layer, aluminum-lithium alloy layer and aluminum layer.

### Example 2

The negative electrode layer of Example 2 was made by overlapping in this order a first aluminum foil with 25 μm thickness, lithium foil, and a second aluminum foil with 75 μm, and press molding at 0.5 ton/cm².

The negative electrode layer of Example 2, from aside of the solid electrolyte layer, is an aluminum layer, aluminum-lithium alloy layer and aluminum layer.

A plurality of negative electrodes of Comparative Example 1 and Examples 1 and 2 were prepared by changing the thickness of the lithium foil, and testing was conducted on the negative electrodes made by changing the compositional ratio of Li and Al.

The detailed configurations of each detailed example are shown in Table 1 below.

In Table 1, first Al foil represents the first aluminum foil, and second Al foil represents the second aluminum foil.

TABLE 1

| | | Comparative | | |
|---|---|---|---|---|
| | | Example | Example 1 | Example 2 |
| | | Thickness | Thickness | Thickness |
| Li_{X}Al_{1-X} | Metal foil type | (μm) | (μm) | (μm) |
| X = 0.44 | Li foil | 100 | 100 | 100 |
| | First Al foil | 100 | 50 | 75 |
| | Second Al foil | | 50 | 25 |
| X = 0.38 | Li foil | 80 | 80 | 80 |
| | First Al foil | 100 | 50 | 75 |
| | Second Al foil | | 50 | 25 |
| X = 0.32 | Li foil | 60 | 60 | 60 |
| | First Al foil | 100 | 50 | 75 |
| | Second Al foil | | 50 | 25 |
| X = 0.24 | Li foil | 40 | 40 | 40 |
| | First Al foil | 100 | 50 | 75 |
| | Second Al foil | | 50 | 25 |
| X = 0.13 | Li foil | 20 | 20 | 20 |
| | First Al foil | 100 | 50 | 75 |
| | Second Al foil | | 50 | 25 |

Solid-state batteries were prepared in which the negative electrodes of Comparative Example 1 and Examples 1 and 2 were incorporated.

Charging/discharging was performed on these solid-stage batteries, and X-ray diffraction measurement was performed from the positive electrode side (solid electrolyte layer side) on the negative electrode of Example 1 after charging/discharging.

The measurement was performed at the conditions of CuFα radiation use, under an inert atmosphere using an X-ray diffractometer (Ultima-3, manufactured by Rigaku).

At this time, the divergence vertical restriction slit was set to 10 mm, the scattering slit was opened, and measurement was conducted with the 20 range from 20 to 80°.

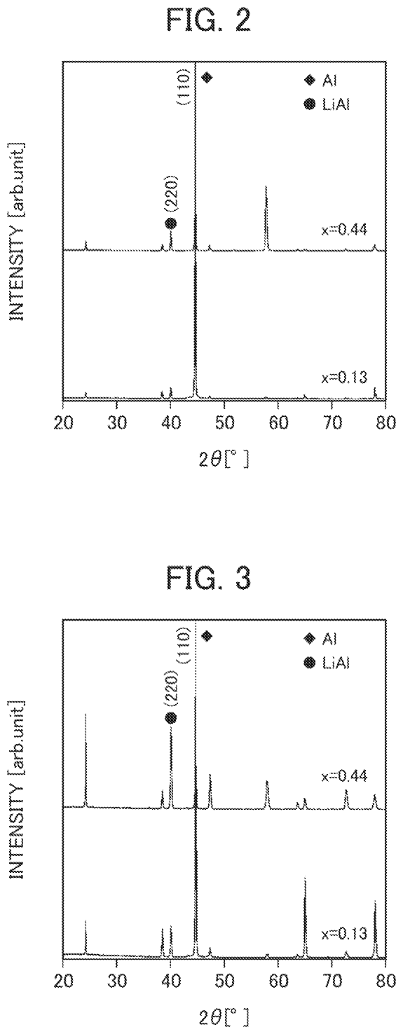

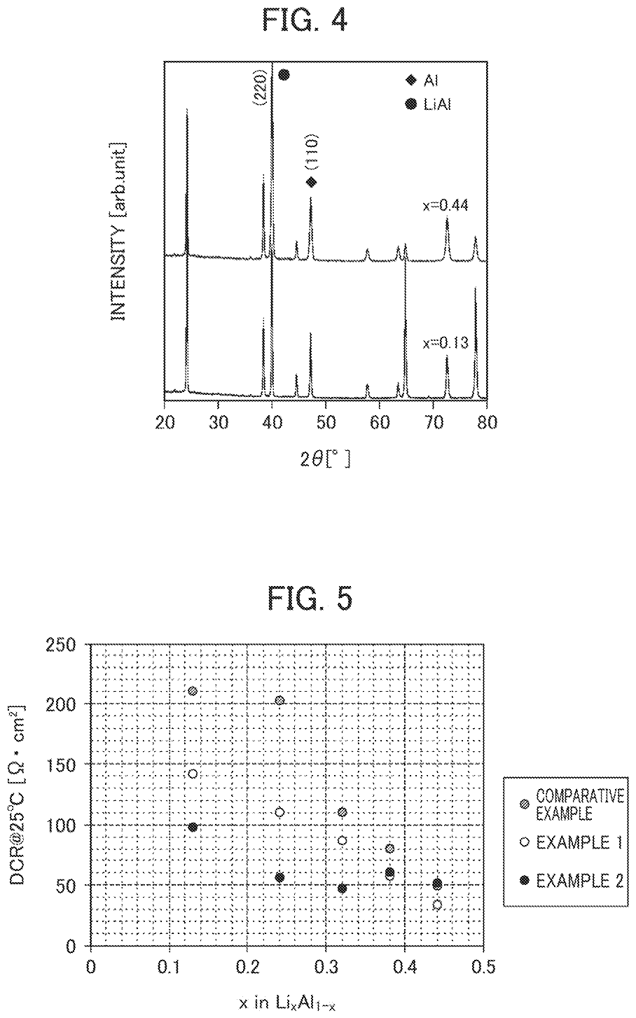

The X-ray diffraction measurement results for Comparative Example 1, Example 1 and Example 2 are shown in FIGS. 2, 3 and 4, respectively.

It should be noted that the compositional ratio Li_{X}Al_{1-X} of Li and Al in the negative electrode layer indicate X=0.13 and 0.44.

When looking at FIGS. 2 to 4, the diffraction peak (2θ=44.58±0.2°) at the (1 1 0) face, which is the peak showing the greatest intensity for Al and the diffraction peak (2θ=39.96±0.2°) at the (2 2 0) face, which is the peak showing the greatest intensity for LiAl, were detected.

The peak of LiAl relative to the peak of Al was detected larger for Examples 1 and 2 than Comparative Example 1, and it is found that alloying of aluminum on the solid electrolyte side of the negative electrode layer advanced.

The peak of LiAl of Example 2 was even larger compared to Example 1, and detected as larger than the peak of Al.

In other words, the ratio of LiAl relative to Al increases as the thickness of the first aluminum layer on the solid electrolyte side thins.

In addition, regarding each example shown in Table 1, results from measuring the ratio I₂₂₀/I₁₁₀ of the intensity I₁₁₀ of the diffraction peak at the (1 1 0) face of Al, and the intensity I₂₂₀ of the diffraction peak at the (2 2 0) face of LiAl, are shown in Table 2.

I₂₂₀/I₁₁₀ is preferably at least 0.1 and no more than 10.

More preferably, I₂₂₀/I₁₁₀ is at least 5.9 and no more than 9.0.

The aluminum layer is sufficiently alloyed on the solid electrolyte layer side of the negative electrode layer, and the negative electrode lithium tends to be released to the positive electrode side without being absorbed to aluminum during discharge; therefore, the internal resistance of the solid-state battery is decreased.

TABLE 2

| | Comparative | | |
|---|---|---|---|
| | Example | Example 1 | Example 2 |
| Li_{X}Al_{1-X} | I₂₂₀/I₁₁₀ | I₂₂₀/I₁₁₀ | I₂₂₀/I₁₁₀ |
| X = 0.44 | 0.03 | 0.1 | 5.93 |
| X = 0.38 | 0.08 | 0.27 | 7.22 |
| X = 0.32 | 0.12 | 0.51 | 7.58 |
| X = 0.24 | 0.17 | 0.79 | 8.39 |
| X = 0.13 | 0.28 | 1.34 | 8.99 |

The results of DC resistance tests are shown in FIG. 5 and Table 3.

DCR resistance was measured at a condition of 10 second discharge from 0.1 C to 5.0 C under a 25° C. environment.

With the solid-state batteries according to Examples 1 and 2, the DCR resistance was lower than that of Comparative Example 1.

In particular, a remarkable decline in resistance from the comparative example was seen from the comparative example in the case of the Li ratio X being small and Al being a high ratio, and with Example 2 setting X=0.24, the DCR resistance decreased by about 72% compared to the comparative example, and improved drastically.

TABLE 3

| | Comparative | | |
|---|---|---|---|
| | Example | Example 1 | Example 2 |
| | DCR resistance | DCR resistance | DCR resistance |
| Li_{X}Al_{1-X} | (Ω · cm²) | (Ω · cm²) | (Ω · cm²) |
| X = 0.44 | 49.28 | 33.74 | 51.08 |
| X = 0.38 | 79.32 | 56.78 | 60.23 |
| X = 0.32 | 109.87 | 85.84 | 47.36 |
| X = 0.24 | 202.24 | 110.26 | 56.29 |
| X = 0.13 | 210.39 | 140.95 | 97.33 |

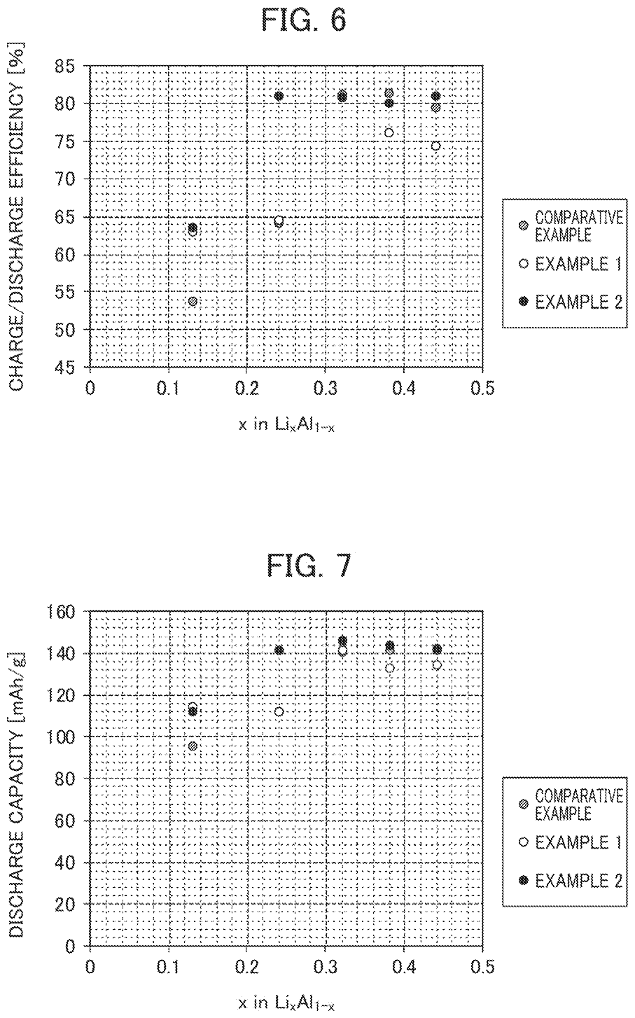

The results of the initial capacity test are shown in FIGS. 6 and 7, and Tables 4 and 5.

The initial capacity test was performed at conditions of 0.1 C (=0.186 mA/cm²) under a 25° C. environment.

As shown in FIG. 6, in the case of the Li ratio X being low and Al being a high ratio, the charge/discharge efficiency improved for Examples 1 and 2 compared to the comparative example.

In addition, as shown in FIG. 7, the discharge capacity has a capacity at least equal to the comparative example, and Example 2 in particular greatly improved in the case of the Li ratio X being low and Al being a high ratio.

TABLE 4

| | Comparative | | |
|---|---|---|---|
| | Example | Example 1 | Example 2 |
| | Discharge | Discharge | Discharge |
| Li_{X}Al_{1-X} | capacity (mAh/g) | capacity (mAh/g) | capacity (mAh/g) |
| X = 0.44 | 141.4 | 134.7 | 142.3 |
| X = 0.38 | 141.5 | 133.2 | 143.7 |
| X = 0.32 | 140.8 | 141.3 | 146.3 |
| X = 0.24 | 111.8 | 111.7 | 141.4 |
| X = 0.13 | 95.6 | 114.5 | 112 |

TABLE 5

| | Comparative | | |
|---|---|---|---|
| | Example | Example 1 | Example 2 |
| | Charge/discharge | Charge/discharge | Charge/discharge |
| Li_{X}Al_{1-X} | efficiency (%) | efficiency (%) | efficiency (%) |
| X = 0.44 | 79.5 | 74.4 | 81 |
| X = 0.33 | 81.4 | 76.2 | 80.1 |
| X = 0.32 | 81.2 | 80.7 | 80.8 |
| X = 0.24 | 64.1 | 64.5 | 80.9 |
| X = 0.13 | 53.7 | 63.1 | 63.5 |

Although a first embodiment of the present invention has been explained above, the present invention is not to be limited to the above embodiment.

Next, a second embodiment of the present invention will be explained.

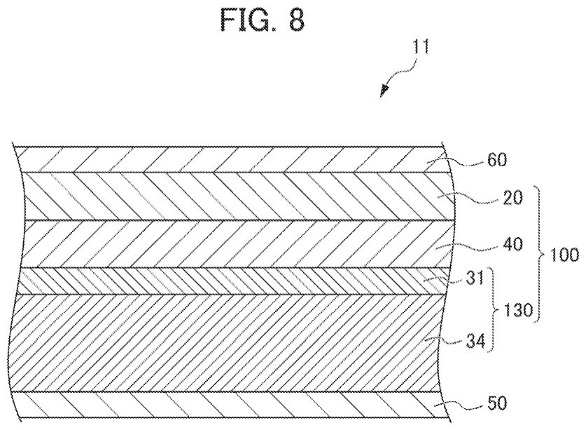

FIG. 8 is a view schematically showing the configuration of a cross section of a solid-state battery 11 according to a second embodiment of the present invention.

A negative electrode layer 130 of the solid-state battery 11 is a member including a first aluminum layer 31 contacting a solid electrolyte layer 40, and an aluminum-lithium alloy layer 34 arranged between a negative collector 50 and first aluminum layer 31.

The aluminum-lithium alloy layer 34 of the present embodiment is entirely aluminum-lithium alloyed until the second aluminum layer 32 of the first embodiment, and the compositional ratio of Li and Al in the negative electrode layer 130 are the same as the first embodiment.

The aluminum-lithium alloy layer 34 of the present embodiment is formed until the negative electrode collector 50, and is formed with a large aluminum ratio compared to the aluminum-lithium alloy layer 33 according to the first embodiment.

It is thereby possible to increase the total amount of aluminum in the negative electrode layer, while thinly forming the first aluminum layer, and thus improve the energy density.

In the present embodiment, the negative electrode layer 130 preferably has a film thickness compositional ratio Li_{X}Al_{1-X} (0≤X≤1) of Li and Al, and the ratio I₂₂₀/I₁₁₀ of the reflection intensity I₂₂₀ of LiAl relative to the reflection intensity I₁₁₀ of Al in X-ray diffraction measurement using CuKα radiation on a surface on the side of the solid electrolyte layer 40 similar to the negative electrode layer 30 of the first embodiment.

### EXPLANATION OF REFERENCE NUMERALS

1, 11 solid-state battery
10, 100 battery main body
20 positive electrode layer
30, 130 negative electrode layer
31 first aluminum layer
32 second aluminum layer
33 aluminum-lithium alloy layer
34 aluminum-lithium alloy layer
40 solid electrolyte layer
50 negative electrode collector
60 positive electrode collector

What is claimed is:

1. A solid-state battery comprising a positive electrolyte layer; a negative electrode layer; and a solid electrolyte layer disposed between the positive electrode layer and the negative electrode layer, wherein the negative electrode layer contains a first aluminum layer contacting the solid-electrolyte layer, and an aluminum-lithium alloy layer.

2. The solid-state battery according to claim 1, wherein X in a compositional ratio LiₓAl₁₋ₓ of lithium and aluminum in the negative electrode layer is in the range of 0.1 to 0.5.

3. The solid-state battery according to claim 1, wherein the negative electrode layer has a ratio I₂₂₀/I₁₁₀ of reflection intensity I₂₂₀ of LiAl relative to reflection intensity I₁₁₀ of Al in X-ray diffraction measurement using CuKα radiation in a surface on a side of the solid electrolyte layer in the range of 0.1 to 10.

4. The solid-state battery according to claim 1, wherein a film thickness of the negative electrode layer is in the range of 10 to 400 μm.

5. The solid-state battery according to claim 1, wherein the negative electrolyte layer further contains a second aluminum layer, wherein the aluminum-lithium alloy layer is disposed to be interposed between the first aluminum layer and the second aluminum layer.

6. The solid-state battery according to claim 1, wherein the solid electrolyte layer consists of a sulfide-based solid electrolyte material.

7. The solid-state battery according to claim 2, wherein the negative electrode layer has a ratio I₂₂₀/I₁₁₀ of reflection intensity I₂₂₀ of LiAl relative to reflection intensity I₁₁₀ of Al in X-ray diffraction measurement using CuKα radiation in a surface on a side of the solid electrolyte layer in the range of 0.1 to 10.

8. The solid-state battery according to claim 2, wherein a film thickness of the negative electrode layer is in the range of 10 to 400 μM.

9. The solid-state battery according to claim 3, wherein a film thickness of the negative electrode layer is in the range of 10 to 400 μm.

10. The solid-state battery according to claim 2, wherein the negative electrolyte layer further contains a second aluminum layer, wherein the aluminum-lithium alloy layer is disposed to be interposed between the first aluminum layer and the second aluminum layer.

11. The solid-state battery according to claim 3, wherein the negative electrolyte layer further contains a second aluminum layer, wherein the aluminum-lithium alloy layer is disposed to be interposed between the first aluminum layer and the second aluminum layer.

12. The solid-state battery according to claim 4, wherein the negative electrolyte layer further contains a second aluminum layer, wherein the aluminum-lithium alloy layer is disposed to be interposed between the first aluminum layer and the second aluminum layer.

13. The solid-state battery according to claim 2, wherein the solid electrolyte layer consists of a sulfide-based solid electrolyte material.

14. The solid-state battery according to claim 3, wherein the solid electrolyte layer consists of a sulfide-based solid electrolyte material.

15. The solid-state battery according to claim 4, wherein the solid electrolyte layer consists of a sulfide-based solid electrolyte material.

16. The solid-state battery according to claim 5, wherein the solid electrolyte layer consists of a sulfide-based solid electrolyte material.
